(19) United States
(12) Patent Application Publication
(10) Pub. No.: US 2019/0094977 A1
(43) Pub. Date: Mar. 28, 2019

(54) INPUT APPARATUS, IMAGE FORMING APPARATUS, AND INPUT METHOD

(71) Applicants: KABUSHIKI KAISHA TOSHIBA, Tokyo (JP); TOSHIBA TEC KABUSHIKI KAISHA, Tokyo (JP)

(72) Inventor: Atsushi Ishihara, Mishima Shizuoka (JP)

(21) Appl. No.: 15/713,908

(22) Filed: Sep. 25, 2017

(51) Int. Cl. G06F 3/01; H04N 1/00; G03G 15/00

(52) U.S. Cl. CPC G06F 3/017; H04N 1/00413; G03G 15/5075; H04N 1/00411; G03G 15/502

(57) ABSTRACT

An input apparatus comprises a touch panel, a hardware key, a sensor, and a controller. The sensor detects a signal indicating an operation by a user received by the touch panel. The controller determines whether or not an external noise is contained in the signal. The controller controls operations of the touch panel and the hardware key based on a determination result.

### FIELD

Embodiments described herein relate generally to an input apparatus, an image forming apparatus, and an input method.

### BACKGROUND

Conventionally, there is known an input apparatus for detecting an operation input by a user through a touch panel.

However, there is a case in which it is difficult for the input apparatus to correctly detect the operation input by the user due to the undesired application of external noise to the touch panel.

### BRIEF DESCRIPTION OF THE DRAWINGS

FIG. 1 is an external view illustrating the whole constitution of an image forming apparatus according to an embodiment;

FIG. 2 is a first diagram illustrating an example of a control panel at the time of a normal operation according to the present embodiment;

FIG. 3 is a second diagram illustrating an example of the control panel at the time of the normal operation according to the present embodiment;

FIG. 4 is a first diagram illustrating an example of an electric signal output by a sensor of the touch panel according to the present embodiment;

FIG. 5 is a second diagram illustrating an example of the electric signal output by the sensor of the touch panel according to the present embodiment;

FIG. 6 is a third diagram illustrating an example of the electric signal output by the sensor of the touch panel according to the present embodiment;

FIG. 7 is a functional constitution diagram illustrating an example of the constitution of the image forming apparatus according to the present embodiment;

FIG. 8 is a first flowchart illustrating an example of the operation of the image forming apparatus according to the present embodiment;

FIG. 9 is a second flowchart illustrating an example of the operation of the image forming apparatus according to the present embodiment;

FIG. 10 is a third flowchart illustrating an example of the operation of the image forming apparatus according to the present embodiment;

FIG. 11 is a first diagram illustrating an example of the control panel in a substitution input mode according to the present embodiment;

FIG. 12 is a fourth flowchart illustrating an example of the operation of an image forming apparatus 1 according to the present embodiment; and

FIG. 13 is a second diagram illustrating an example of the control panel in the substitution input mode according to the present embodiment.

### DETAILED DESCRIPTION

In accordance with an embodiment, an input apparatus comprises a touch panel, a hardware key, a sensor, and a controller. The sensor detects a signal indicating an operation by a user received by the touch panel. The controller determines whether or not an external noise is contained in the signal. The controller controls operations of the touch panel and the hardware key based on a determination result of the determination section.

In accordance with another embodiment, an input method, associated with an input apparatus comprising a touch panel and a hardware key, involves detecting a signal indicating an operation from a user received by the touch panel; determining whether or not an external noise is contained in the signal; and controlling operations of the touch panel and the hardware key based on a determination result.

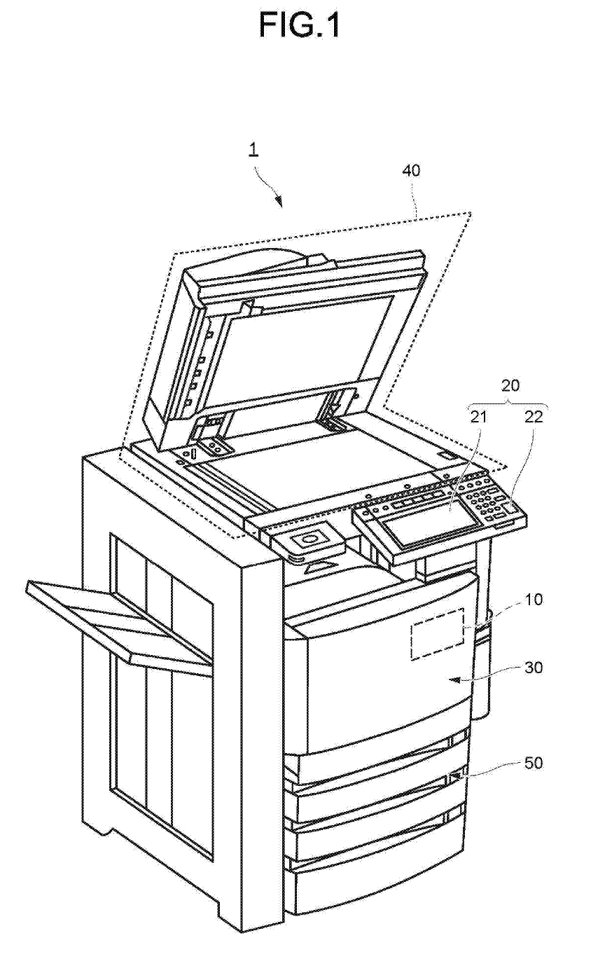

Hereinafter, an input apparatus of an embodiment is described with reference to the accompanying drawings. FIG. 1 is an external view illustrating the whole constitution of an image forming apparatus 1 according to the present embodiment.

The image forming apparatus 1 forms an image on a sheet-like image receiving medium (hereinafter, referred to as a “sheet”) such as a paper. For example, the image forming apparatus 1 is an MFP (Multi-Function Peripheral) which is a multifunction machine, a printer, a copying machine and the like. The sheet is not limited to the paper, but includes a plastic sheet such as an OHP (overhead projector) sheet.

The image forming apparatus 1 includes a controller 10, a control panel 20, a printing section 30, a scanner section 40, and a sheet feed section 50.

The control panel 20 includes various keys or a touch panel for receiving an operation by a user. In an example of the present embodiment, the control panel 20 includes a touch panel 21 which is formed integrally with a display section and a hardware key 22. The touch panel 21 and the hardware key 22 receive the operation by the user. The operations by the user include, for example, an operation of setting image formation on the sheet, an operation of instructing a processing displayed on the touch panel 21, an operation of executing a processing assigned to the hardware key 22, and the like.

The scanner section 40 includes a reading section that reads a copied object. The scanner section 40 sends image information indicating an image of the read copied object to the printing section 30.

Based on the image information sent from the scanner section 40 or an external device, the printing section 30 forms an output image (hereinafter, referred to as a “toner image”) with a developer such as a toner. The printing section 30 transfers the toner image onto the surface of the sheet. The printing section 30 applies heat and pressure to the toner image transferred onto the sheet to fix the toner image on the sheet.

The sheet feed section 50 supplies the sheets one by one in accordance with a timing at which the printing section 30 forms the toner image.

The controller 10 controls the overall operation of the image forming apparatus 1. The controller 10 controls the control panel 20, the printing section 30, the scanner section 40 and the sheet feed section 50. The controller 10 is formed of a control circuit including a CPU (Central Processing Unit), a ROM (Read Only Memory), and a RAM (Random Access Memory).

The details of the control panel 20 are described below.

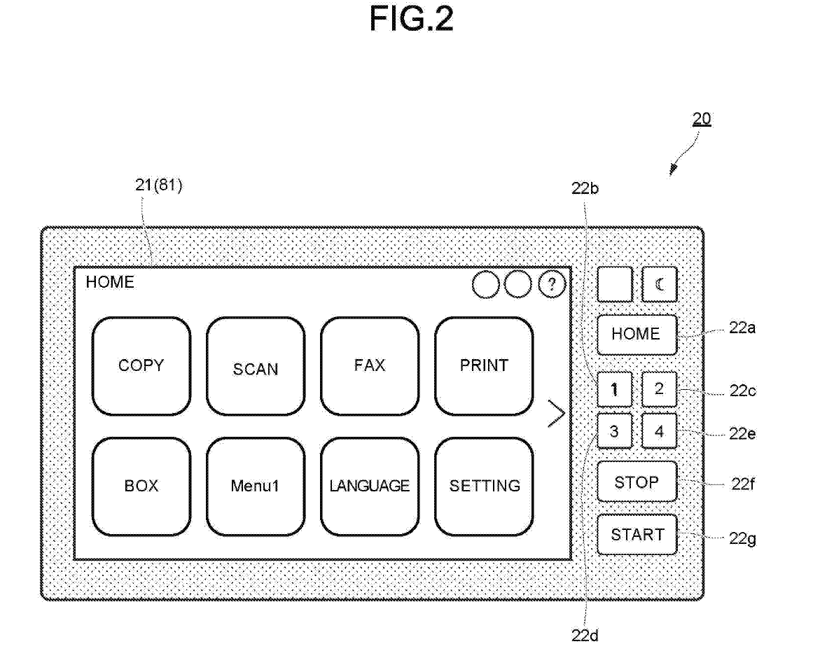

FIG. 2 is a first diagram illustrating an example of the control panel 20 at the time of a normal operation according to the present embodiment. As described above, the touch panel 21 is integrated with the display section and displays an image 80 under the control of the controller 10. In the example shown in FIG. 2, on the touch panel 21, the image 80 (hereinafter, referred to as a home image 81) indicating a home screen of the image forming apparatus 1 is displayed. The home image 81 is, for example, displayed on the touch panel 21 in a state in which the touch panel 21 operates normally (hereinafter, referred to as a normal operation mode). The normal operation mode refers to a state in which the touch panel 21 is not influenced by the external noise or undergoes the external noise to such an extent that the external noise does not affect the operation of the touch panel 21. The external noise is, for example, an electrostatic discharge noise, a fast-transient burst noise, a conductive electromagnetic field noise, a radiated electromagnetic field noise, or the like.

For example, the home image 81 shows various processing executed by the image forming apparatus 1. The various processing executed by the image forming apparatus 1 include, for example, copying, scanning, faxing, printing of the image information and various settings. The touch panel 21 receives an operation executed by the user on the touch panel 21. The operation executed by the user on the touch panel 21 is, for example, an operation for instructing a certain position on the touch panel 21 (hereinafter, referred to as an instruction operation). The user instructs a certain position on the touch panel 21 by the instruction operation. Hereinafter, the certain position on the touch panel 21 instructed through the instruction operation by the user is described as an instructed position.

Here, the touch panel 21 of the control panel 20 is, for example, a capacitance type touch panel. In this case, the touch panel 21 includes a plurality of sensors for detecting a change in the capacitance together with the instruction operation by the user and outputting the detected change by the electric signal. In the touch panel 21, the sensor is placed on a matrix. The touch panel 21 detects a position where an electric signal indicating the change in the electrostatic capacity output by the sensor exceeds a predetermined threshold value (hereinafter, referred to as a threshold value TH) as the instructed position. The touch panel 21 supplies information (hereinafter, referred to as instructed position information) indicating the instructed position on the touch panel 21 by the XY coordinates to the controller 10. The controller 10 recognizes the operation based on the image 80, the operation associated with the image 80, the position of the operation on the image 80, and the instructed position information. In the following description, the sensors provided in the touch panel 21 are simply described as a sensor. The sensor is an example of the signal detection section.

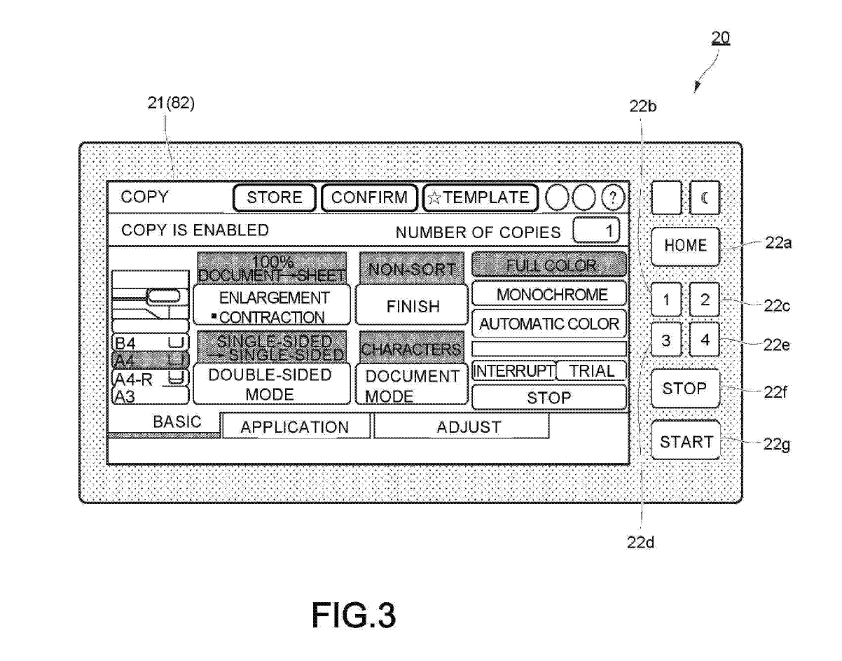

FIG. 3 is a second diagram illustrating an example of the control panel 20 at the time of the normal operation according to the present embodiment. In the example shown in FIG. 3, an image 80 (hereinafter, referred to as a copy setting image 82) relating to copy setting is displayed on the touch panel 21. For example, the copy setting image 82 is displayed if the touch panel 21 receives the instruction operation indicating a position of the “copy” on the home image 81. In response to display of the copy setting image 82, the touch panel 21 receives an operation by the user relating to the setting of the “copy”.

As shown in FIG. 2 and FIG. 3, the control panel 20 includes a plurality of the hardware keys 22. The hardware key 22 receives an operation associated in advance which is an operation different from the operation received by the touch panel 21. For example, the hardware key 22 includes a numeric keypad for inputting the number of copies or a telephone number of the destination of the fax. For example, the hardware key 22 includes a home button for returning the display of the touch panel 21 to the home image 81. For example, the hardware key 22 includes a stop button for interrupting various processing executed by the image forming apparatus 1. For example, the hardware key 22 includes a start button for starting various processing executed by the image forming apparatus 1. In one example of the present embodiment, a case is described in which the control panel 20 includes seven hardware keys 22, i.e., hardware keys 22a to 22g.

In the above description, a case in which the hardware key 22 receives the operation by the user different from the operation received by the touch panel 21 is described, but the present invention is not limited thereto. A matching operation may be associated with the touch panel 21 and the hardware key 22. In this case, the user inputs an operation using either the touch panel 21 or the hardware key 22.

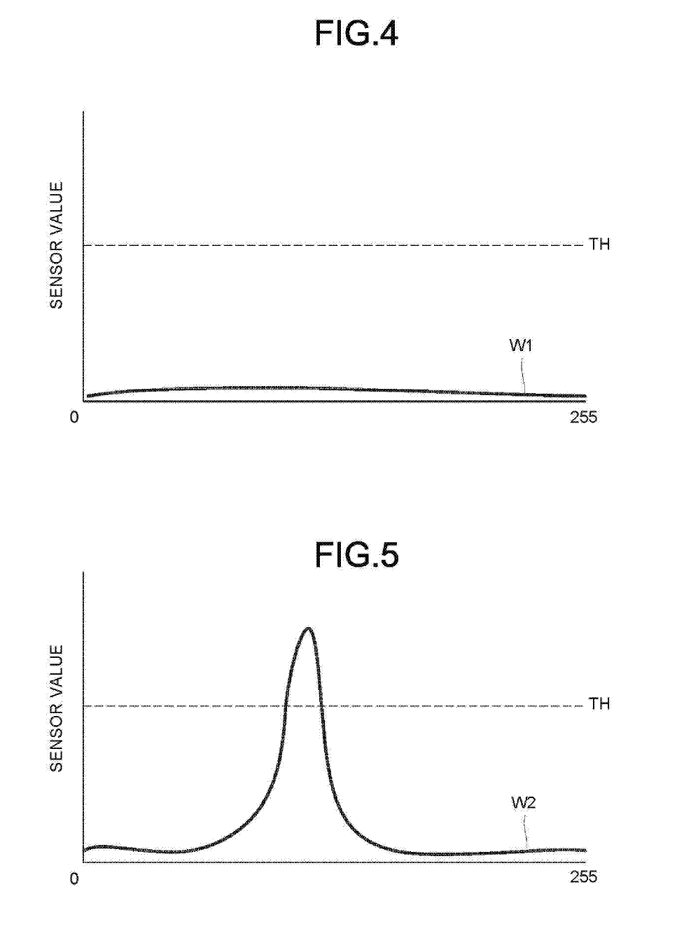

The details of the external noise applied to the touch panel 21 are described below with reference to FIG. 4 to FIG. 6.

FIG. 4 is a first diagram illustrating an example of an electric signal output by the sensor of the touch panel 21 according to the present embodiment.

The vertical axis in FIG. 4 to FIG. 6 shows the magnitude (hereinafter, referred to as a sensor value) of the electric signal output by the sensor. The horizontal axis shows an X axis coordinate or a Y axis coordinate of the sensor. In an example of the present embodiment, a case is described in which the sensor has 0 to 255 coordinates in both an X axis direction and a Y axis direction. FIG. 4 to FIG. 6 show the sensor values in the X axis direction output by the sensor. A waveform W1 shown in FIG. 4 shows the sensor value output by the sensor if the instruction operation by the user is not received.

If the user executes the instruction operation on the touch panel 21, the sensor value rises. The waveform W1 depicted in FIG. 4 shows sensor values if the touch panel 21 does not receive the instruction operation by the user.

FIG. 5 is a second diagram illustrating an example of the electric signal output by the sensor of the touch panel 21 according to the present embodiment. A waveform W2 shown in FIG. 5 shows sensor values output by the sensor if the instruction operation by the user is received. In the Waveform W2 shown in FIG. 5, the sensor values around the center (X coordinate: 128) rise and exceed the threshold value TH. As described above, the touch panel 21 detects, as the instructed position, a position where the electric signal indicating the change in the capacitance output by the sensor exceeds the threshold value TH. The touch panel 21 supplies the controller 10 with the instructed position information indicating the instructed position on the touch panel 21 with XY coordinates.

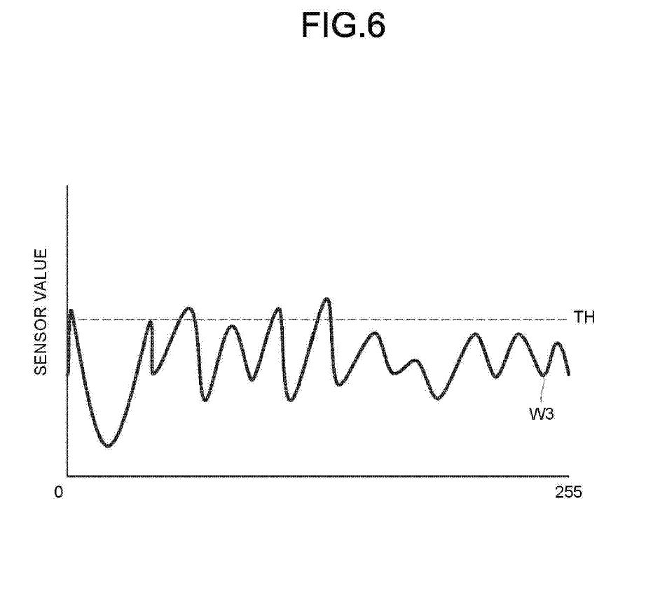

FIG. 6 is a third diagram illustrating an example of the electric signal output by the sensor of the touch panel 21 according to the present embodiment. A waveform W3 shown in FIG. 6 shows sensor values output by the sensor.

Here, if the external noise is applied to the image forming apparatus 1 (the touch panel 21), the sensor value output by the sensor is biased. In this case, even if the touch panel 21 does not receive the instruction operation by the user, there is a possibility of erroneously detecting the instruction operation.

The image forming apparatus 1 of the present embodiment receives the operation by the user without using the touch panel 21 if the external noise is applied to the image forming apparatus 1 (the touch panel 21). A specific constitution of the image forming apparatus 1 is described below.

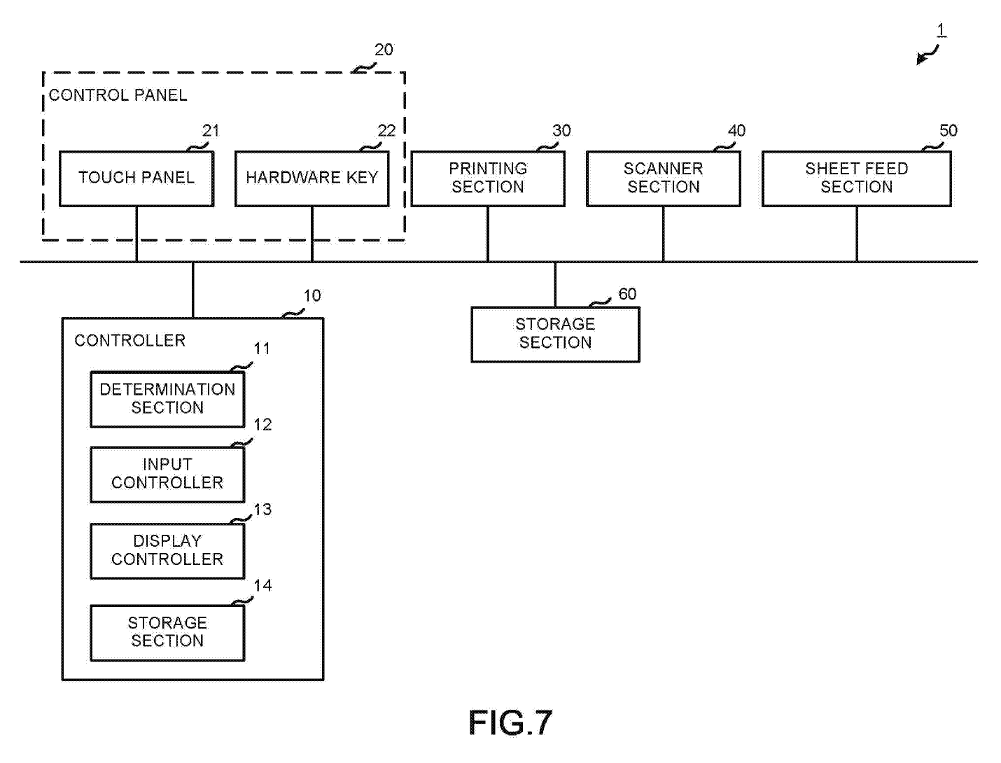

FIG. 7 is a functional constitution diagram illustrating an example of the constitution of the image forming apparatus 1 according to the present embodiment. The image forming apparatus 1 includes the controller 10, the control panel 20 (the touch panel 21 and the hardware key 22), the printing section 30, the scanner section 40, the sheet feed section 50 and a storage section 60. Each section of the image forming apparatus 1 is connected to be capable of transmitting and receiving information. The controller 10 includes a storage section 14. The storage section 14 stores programs and a plurality of the images 80. The controller 10 has the CPU, and executes a program stored in the storage section 14 to realize various functions. The storage section 14 is a ROM (Read Only Memory) and a RAM (Random Access Memory). In an example of the present embodiment, the controller 10 realizes a determination section 11, an input controller 12, and a display controller 13 as functional sections thereof.

Based on the electric signal output by the sensor, the determination section 11 determines whether or not the external noise is contained in the electric signal.

The input controller 12 controls the operations of the touch panel 21 and the hardware key 22 based on the determination result of the determination section 11.

The display controller 13 displays the image 80 stored in the storage section 14 on the touch panel 21 based on the determination result of the determination section 11.

The storage section 60 stores image data received from a client terminal or a scanner. The storage section 60 is an HDD (Hard Disk Drive) or an SSD (Solid State Drive).

Hereinafter, the operation of the image forming apparatus 1 is described with reference to the drawings.

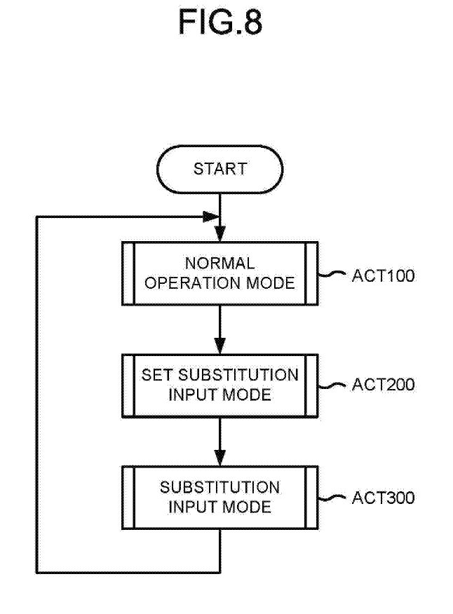

FIG. 8 is a first flowchart illustrating an example of the operation of the image forming apparatus 1 according to the present embodiment.

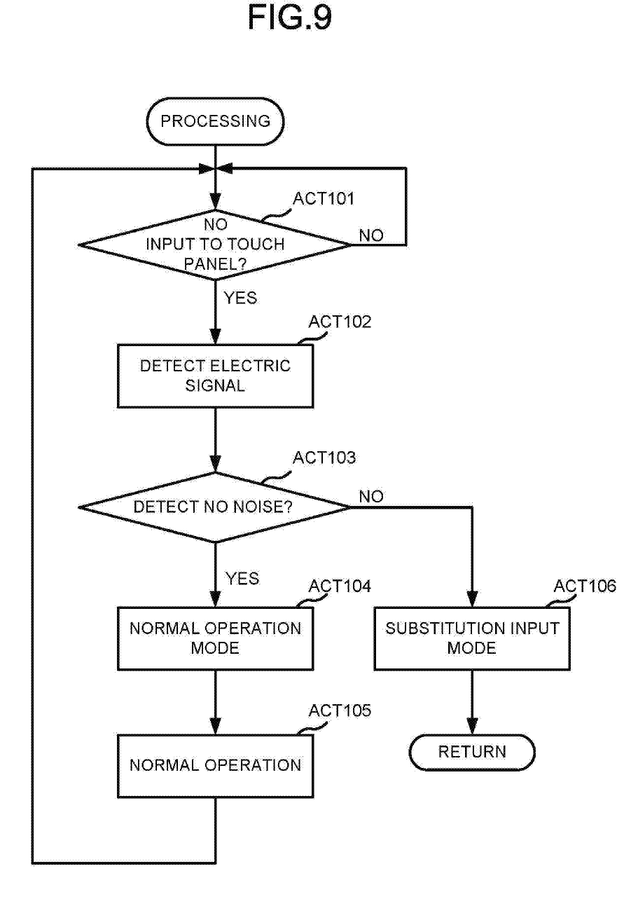

If the external noise is not applied, the image forming apparatus 1 (the touch panel 21) operates in the normal operation mode (ACT 100). Hereinafter, details of the processing in ACT 100 are described with reference to FIG. 9.

FIG. 9 is a second flowchart illustrating an example of the operation of the image forming apparatus 1 according to the present embodiment. Specifically, FIG. 9 is a flowchart illustrating an example of the operation in a case in which the image forming apparatus 1 operates in the normal operation mode.

The touch panel 21 determines whether or not the touch panel 21 receives the operation by the user (ACT 101). The state in which the touch panel 21 receives the operation by the user refers to, for example, a state in which each section of the image forming apparatus 1 operates based on the operation of the user received by the touch panel 21. If the operation by the user is received (No in ACT 101), the touch panel 21 does not execute a processing (hereinafter referred to as a determination processing) that determines whether or not the external noise is applied. If the touch panel 21 does not receive the operation by the user (Yes in ACT 101), the sensor detects the electric signal accompanying the determination processing (ACT 102). The determination section 11 determines whether or not the external noise is contained in the electric signal detected by the sensor (ACT 103).

The case in which the determination section 11 determines that the external noise is not contained in the electric signal includes a state in which the external noise is not contained in the electric signal at all. The case in which the determination section 11 determines that the external noise is not contained in the electric signal includes a state of containing the external noise to the extent that the external noise does not affect the operation of the touch panel 21. The case in which the determination section determines that the external noise is contained in the electric signal includes a state in which a plurality of the instructed positions is detected and a state in which the instructed position indicating a plurality of operations is detected according to the electric signal. In other words, the case in which the determination section 11 determines that the external noise is contained in the electric signal refers to a case in which it is difficult to recognize the operation by the user according to the electric signal.

The determination section 11 determines that the touch panel 21 can operate in the normal operation mode (ACT 104) if the external noise is not contained in the electric signal (Yes in ACT 103). In this case, the input controller 12 enables the touch panel 21 and the hardware key 22 to normally operate (ACT 105). The normal operation of the touch panel 21 is, for example, an operation of receiving the instruction operation corresponding to the image 80 displayed on the touch panel 21. If the touch panel 21 executes the normal operation, the controller 10 controls each section of the image forming apparatus 1 based on the instructed position information acquired from the touch panel 21 to execute various processing. The normal operation of the hardware key 22 is, for example, an operation of receiving operations previously associated with the hardware keys 22a to 22f. If the touch panel 21 executes the normal operation, the controller 10 controls each section of the image forming apparatus 1 based on the information indicating the operation received by the hardware key 22 to execute various processing.

The controller 10 executes the determination processing (ACT 101 to ACT 105) at predetermined time intervals.

The determination section 11 determines that the control panel 20 operates in a substitution input mode (ACT 106) if the external noise is contained in the electric signal (No in ACT 103). The substitution input mode refers to an operation method of receiving an operation received by the touch panel 21 by the hardware key 22. The controller 10 proceeds to the processing in ACT 200.

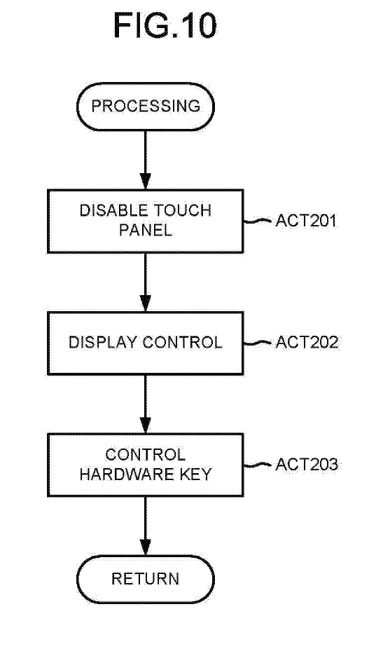

Returning to FIG. 8, the controller 10 executes various setting processing while the control panel 20 operates in the substitution input mode (ACT 200). The details of the processing in ACT 200 are described below with reference to FIG. 10.

FIG. 10 is a third flowchart illustrating an example of the operation of the image forming apparatus 1 according to the present embodiment. Specifically, FIG. 10 is a flowchart illustrating an example of the operation in a case of carrying out various setting processing accompanying the operation of the control panel 20 in the substitution input mode.

The input controller 12 disables the operation received by the touch panel 21 if the control panel 20 operates in the substitution input mode (ACT 201). Specifically, the input controller 12 masks the instructed position information output from the touch panel 21. In this case, the controller 10 does not control each section based on the instructed position information output by the touch panel 21.

If the control panel 20 operates in the substitution input mode, the display controller 13 displays the image 80 stored in the storage section 14 on the touch panel 21 (ACT 202).

The details of the image 80 in the substitution input mode are described below.

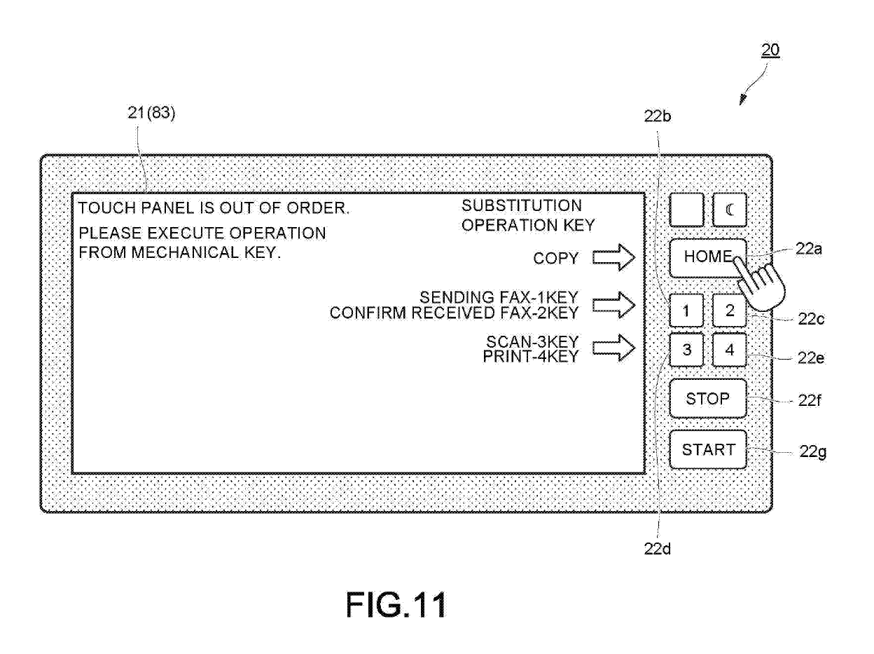

FIG. 11 is a first diagram illustrating an example of the control panel 20 in the substitution input mode according to the present embodiment. The display controller 13 displays the image 80 (hereinafter, referred to as a substitution mode image 83) indicating that the substitution input mode is set on the touch panel 21. The substitution mode image 83 includes a notification indicating that the touch panel 21 operates in the substitution input mode. For example, the notification is a notice such as “the touch panel is out of order, please execute the operation from mechanical keys”. The substitution mode image 83 includes information indicating the correspondence between the operation received by the touch panel 21 and the hardware key 22. Specifically, the substitution mode image 83 is used to urge the user to press the hardware key 22a (“HOME” key shown in FIG. 11) in the case of “copy”. The substitution mode image 83 is used to urge the user to press the hardware key 22b (“1” key shown in FIG. 11) in the case of “sending fax”. The substitution mode image 83 is used to urge the user to press the hardware key 22c (“2” key shown in FIG. 11) in the case of “confirming the received fax”. The substitution mode image 83 is used to urge the user to press the hardware key 22d (“3” key shown in FIG. 11) in a case of executing “scanning”. The substitution mode image 83 is used to urge the user to press the hardware key 22e (“4” key shown in FIG. 11) in a case of executing “printing”.

Returning to FIG. 10, the input controller 12 controls the operation of the hardware key 22 in response to the key displayed on the substitution mode image 83 (ACT 203). Specifically, the input controller 12 controls the operation of the hardware key 22 to receive the operation received by the touch panel 21 by the hardware key 22. For example, the correspondence information indicated by the image 80 and the image 80 are stored in the storage section 14 in an associated manner. The correspondence information indicates correspondence between the operation received by the touch panel 21 indicated by the image 80 and the hardware key 22.

Based on the image 80 displayed on the touch panel 21, for example, the input controller 12 reads out the correspondence information associated with the image 80. The controller 10 recognizes the operation based on the correspondence information read out by the input controller 12 and the signal which is output accompanying the press on the hardware key 22. The controller 10 controls each section of the image forming apparatus 1 according to the recognized operation.

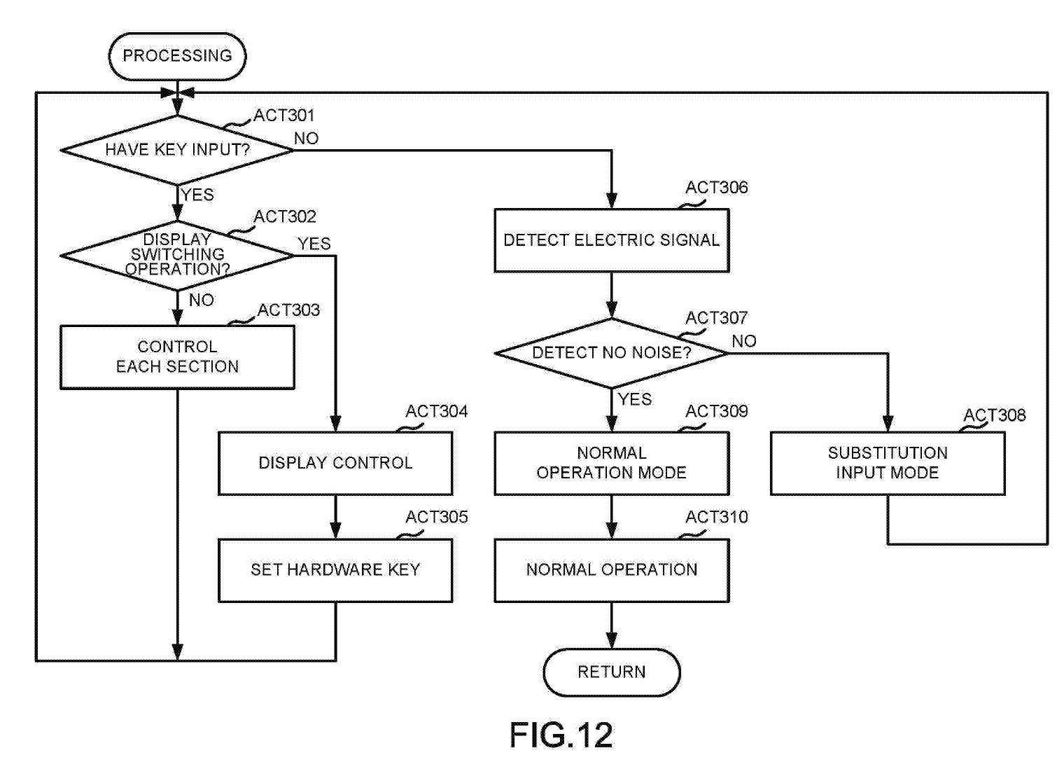

Returning to FIG. 8, the controller 10 operates as the substitution input mode based on various settings made in the ACT 200 (ACT 300). The details of the processing in ACT 300 are described below with reference to FIG. 12.

FIG. 12 is a fourth flowchart illustrating an example of the operation of the image forming apparatus 1 according to the present embodiment. Specifically, FIG. 12 is a flowchart illustrating an example of the operation if the control panel 20 operates in the substitution input mode.

The controller 10 determines whether or not the hardware key 22 receives the input (ACT 301). If the hardware key 22 receives an input (Yes in ACT 301), the controller 10 determines whether or not the input indicates an operation of switching the display (ACT 302). If the input does not indicate the operation of switching the display (No in ACT 302), the controller 10 controls each section of the image forming apparatus 1 according to the operation (ACT 303). If the input indicates the operation of switching the display (Yes in ACT 302), the display controller 13 displays the image 80 on the touch panel 21 in response to the operation (ACT 304). The input controller 12 reads out the correspondence information corresponding to the image 80 displayed on the touch panel 21 (ACT 305). Thereafter, the controller 10 recognizes the operation based on the correspondence information read by the input controller 12 and controls each section of the image forming apparatus 1.

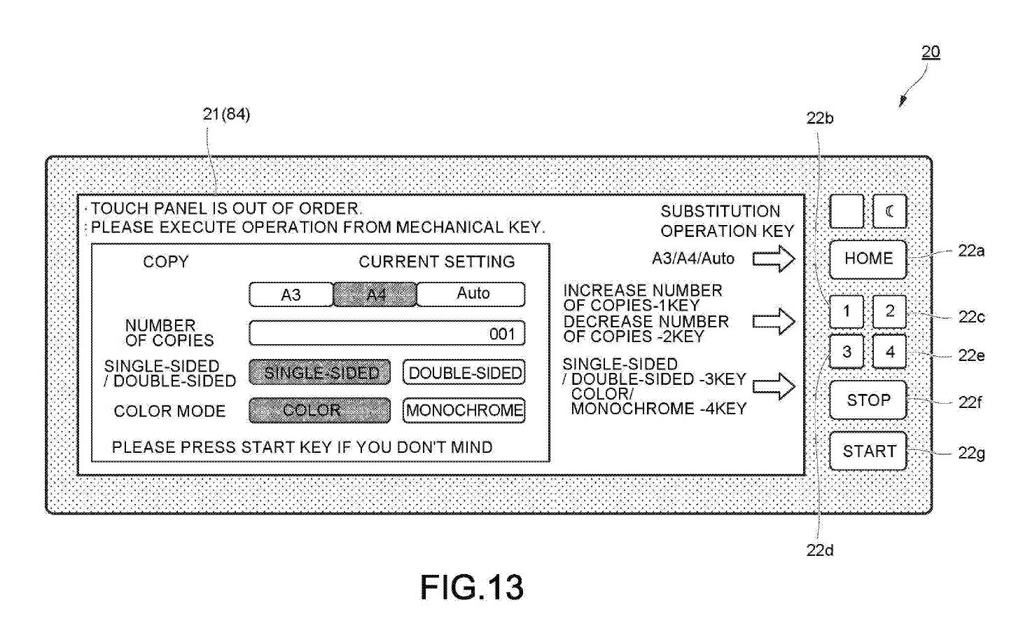

FIG. 13 is a second diagram illustrating an example of the control panel 20 in the substitution input mode according to the present embodiment. FIG. 13 shows an example of the image 80 (hereinafter, referred to as a substitution copy mode image 84) relating to the copy setting if the hardware key receives an input for switching the screens. The substitution copy mode image 84 is displayed in response to pressing on the hardware key 22a in a state in which the substitution mode image 83 is displayed.

Specifically, the substitution copy mode image 84 urges the user to press the hardware key 22a (“HOME” key shown in FIG. 13) in a case of changing a paper size. The substitution copy mode image 84 urges the user to press the hardware key 22b (“1” key shown in FIG. 13) in the case of “increasing number of copies” in the copy. The substitution copy mode image 84 urges the user to press the hardware key 22c (“2” key shown in FIG. 13) in the case of “decreasing number of copies” in the copy. The substitution copy mode image 84 urges the user to press the hardware key 22d (“3” key shown in FIG. 13) in a case of switching the “single-sided/double-sided” in the copy. The substitution copy mode image 84 urges the user to press the hardware key 22e (“4” key shown in FIG. 13) in a case of switching the “color/monochrome” in the copy.

Returning to FIG. 12, if the hardware key 22 does not receive the input (No in ACT 301), the sensor detects the electric signal accompanying the determination processing (ACT 306). The determination section 11 determines the operation mode of the touch panel 21 based on whether the external noise is contained in the electric signal detected by the sensor (ACT 307). If the external noise is not contained in the electric signal (Yes in ACT 307), the determination section 11 determines that the touch panel 21 can operate in the normal operation mode (ACT 309). In this case, the input controller 12 enables the touch panel 21 and the hardware key 22 to operate normally (ACT 310). If the external noise is contained in the electric signal (No in ACT 307), the determination section 11 determines that the control panel 20 operates in the substitution input mode (ACT 308). The controller 10 executes the processing (ACT 306 to ACT 310) to determine whether the normal operation of the touch panel 21 is enabled at predetermined time intervals.

As described above, the image forming apparatus 1 of the present embodiment comprises the controller 10, the touch panel 21 and the hardware key 22. The touch panel 21 includes the sensor. The controller 10 includes the determination section 11 and the input controller 12. The sensor detects the electric signal indicating the operation by the user received by the touch panel 21. The determination section 11 determines whether or not the external noise is contained in the electric signal detected by the sensor. The input controller 12 controls the operations of the touch panel 21 and the hardware key 22 based on the determination result of the determination section 11. In particular, the input controller 12 enables the control panel 20 to operate in the substitution input mode if the determination result of the determination section 11 indicates that the external noise is contained in the electric signal.

As a result, the image forming apparatus 1 of the present embodiment can receive the operation by the user even if the touch panel 21 cannot receive the operation due to the external noise.

In the substitution input mode of the image forming apparatus 1 of the present embodiment, a plurality of the hardware keys 22 is associated with different operations. Thereby, the image forming apparatus 1 of the present embodiment can receive the plurality of operations by the hardware keys 22.

The image forming apparatus 1 of the present embodiment comprises the display section formed integrally with the touch panel 21 and the display controller 13. The display controller 13 displays the image 80 (e.g., the substitution mode image 83 and the substitution copy mode image 84) showing the correspondence between the operation by the user and the hardware key 22 on the display section. As a result, the image forming apparatus 1 of the present embodiment can present various operations associated with the hardware key 22 in an easy-to-understand manner to the user.

The image forming apparatus 1 of the present embodiment displays the image (e.g., the substitution mode image 83 and the substitution copy mode image 84) including the notification indicating the substitution input mode on the display section. Thus, the image forming apparatus 1 of the present embodiment can present that the operation is received by the hardware key 22 instead of the touch panel 21 in an easy-to-understand manner to the user.

The image forming apparatus 1 of the present embodiment associates the operation of switching the images 80 displayed on the touch panel 21 with the hardware key 22a in the substitution input mode. The display controller 13 switches the images 80 displayed on the touch panel 21 if the hardware key 22a receives the operation. For example, in the state in which the substitution mode image 83 is displayed, the display controller 13 displays the substitution copy mode image 84 if the hardware key 22a receives the operation. Thereby, the image forming apparatus 1 of the present embodiment can receive more detailed setting relating to the image formation by the hardware key 22.

At the time the image forming apparatus 1 of the present embodiment operates in the substitution input mode, if the determination section 11 determines that the external noise is not contained in the electric signal, the touch panel 21 receives the operation by the user under the control of the input controller 12.

Thereby, the image forming apparatus 1 of the present embodiment can switch the devices for receiving the operation by the user according to a detection condition of the external noise without the input operation by the operator. In an example of the present embodiment, the devices that receive the operation by the user are the touch panel 21 and the hardware key 22. In other words, the image forming apparatus 1 of the present embodiment can switch input from the touch panel 21 and the input from the hardware key 22 without intervention by the operator.

In the above description, the determination section 11 determines to operate in the substitution input mode if the external noise is included in the electric signal, but the present invention is not limited thereto. The touch panel 21 may calibrate levels of the electric signal on which the external noise is superimposed, for example. As a result, the touch panel 21 can receive the operation by the user by setting the electric signal superposed with the external noise as a reference level.

While certain embodiments have been described these embodiments have been presented by way of example only, and are not intended to limit the scope of the inventions. Indeed, the novel embodiments described herein may be embodied in a variety of other forms: furthermore various omissions, substitutions and changes in the form of the embodiments described herein may be made without departing from the spirit of the inventions. The accompanying claims and there equivalents are intended to cover such forms or modifications as would fall within the scope and spirit of the invention.

What is claimed is:

1. An input apparatus, comprising:
a touch panel;
a hardware key;
a sensor configured to detect a signal indicating an operation from a user received by the touch panel; and
a controller configured to:
determine whether or not an external noise is contained in the signal, and
control operations of the touch panel and the hardware key based on a determination result.

2. The input apparatus according to claim 1, wherein
the hardware key receives the operation from the user under the control of the controller if the controller determines that the external noise is contained in the signal.

3. The input apparatus according to claim 1, wherein
the controller associates different operations to the hardware key if the controller determines that the external noise is contained in the signal.

4. The input apparatus according to claim 1, further comprising:
a display;
wherein the controller configured to:
control display on the display, and
display an image indicating correspondence between the operation from the user and the hardware key on the display.

5. The input apparatus according to claim 4, wherein
the controller displays an image indicating that the hardware key receives the operation from the user on the display if the controller determines that the external noise is contained in the signal.

6. The input apparatus according to claim 4, wherein
the controller displays an image indicating that the touch panel does not receive the operation from the user on the display if the controller determines that the external noise is contained in the signal.

7. The input apparatus according to claim 4, wherein
the controller associates a switching operation for switching the images with the hardware key, and switches the images displayed on the display depending on reception of an operation on the hardware key associated with the switching operation.

8. The input apparatus according to claim 1, wherein
the hardware key receives an operation associated with the hardware key in advance under the control of the controller if the touch panel receives the operation from the user.

9. An image forming apparatus comprising an input apparatus, the input apparatus comprising:
a touch panel;
a hardware key;
a sensor configured to detect a signal indicating an operation from a user received by the touch panel; and
a controller configured to:
determine whether or not an external noise is contained in the signal,
control operations of the touch panel and the hardware key based on a determination result, and
the touch panel receives an operation by the user under the control of the controller if the controller determines that the external noise is not contained in the signal after determining that the external noise is contained in the signal.

10. The image forming apparatus according to claim 9, wherein
the hardware key receives the operation from the user under the control of the controller if the controller determines that the external noise is contained in the signal.

11. The image forming apparatus according to claim 9, further comprising:
a display; and
wherein the controller configured to:
control display on the display, and
display an image indicating correspondence between the operation from the user and the hardware key on the display.

12. The image forming apparatus according to claim 11, wherein
the controller displays an image indicating that the hardware key receives the operation from the user on the display if the controller determines that the external noise is contained in the signal.

13. The image forming apparatus according to claim 11, wherein
the controller displays an image indicating that the touch panel does not receive the operation from the user on the display if the controller determines that the external noise is contained in the signal.

14. The image forming apparatus according to claim 9, wherein
the hardware key receives an operation associated with the hardware key in advance under the control of the controller if the touch panel receives the operation from the user.

15. An input method associated with an input apparatus comprising a touch panel and a hardware key, comprising:
detecting a signal indicating an operation from a user received by the touch panel;
determining whether or not an external noise is contained in the signal; and
controlling operations of the touch panel and the hardware key based on a determination result.

16. The input method according to claim 15, further comprising:
associating different operations to the hardware key if the external noise is contained in the signal.

17. The input method according to claim 15, further comprising:
displaying an image indicating correspondence between the operation from the user and the hardware key on a display.

18. The input method according to claim 17, further comprising:
displaying an image indicating that the hardware key receives the operation from the user on the display if the external noise is contained in the signal.

19. The input method according to claim 17, further comprising:
displaying an image indicating that the touch panel does not receive the operation from the user on the display if the external noise is contained in the signal.

20. The input method according to claim 17, further comprising:
associating a switching operation for switching the images with the hardware key, and
switching the images displayed on the display section depending on reception of an operation on the hardware key associated with the switching operation.
